(19) United States
(12) Patent Application Publication
(10) Pub. No.: US 2023/0316595 A1
(43) Pub. Date: Oct. 5, 2023

(54) Microscopy Virtual Staining Systems and Methods

(71) Applicant: Georgia Tech Research Corporation, Atlanta, GA (US)

(72) Inventors: Francisco E. Robles, Atlanta, GA (US); Nischita Kaza, Atlanta, GA (US)

(21) Appl. No.: 18/065,162

(22) Filed: Dec. 13, 2022

Related U.S. Application Data
(60) Provisional application No. 63/288,800, filed on Dec. 13, 2021.

(51) Int. Cl. G06T 11/00; G01N 21/33; G06T 7/90; G06V 20/69; G06V 10/82

(52) U.S. Cl. CPC G06T 11/001; G01N 21/33; G06T 7/90; G06V 10/82; G06V 20/695; G06V 20/698; G06T 2207/10024; G06T 2207/20081; G06T 2207/20084; G06T 2207/30024

(57) ABSTRACT

An exemplary embodiment of the present disclosure provides a method of virtually staining a biological sample, comprising: obtaining one or more UV images of the biological sample; generating a virtually stained image of the biological sample, comprising: generating a first data set for the one or more images, the first data set comprising at least one data value for each pixel of the one or more UV images; inputting the first data set into a deep learning neural network to generate one or more additional data sets, the one or more additional data sets comprising at least one data value corresponding to a value in a color model for each pixel in the one or more UV images; and creating virtually stained image of the biological sample using at least the one or more additional data sets.

### CROSS-REFERENCE TO RELATED APPLICATIONS

This application claims the benefit of U.S. Provisional Application Serial No. 63/288,800 filed on 13 Dec. 2021, which is incorporated herein by reference in its entirety as if fully set forth below.

### GOVERNMENT LICENSE RIGHTS

This invention was made with government support under NSF CBET CAREER No. 1752011 by the National Science Foundation. The government has certain rights in this invention.

### FIELD OF THE DISCLOSURE

Embodiments of the present disclosure relate to microscopy virtual staining systems and methods. Particularly, embodiments of the present disclosure relate to Deep learning based virtual staining of label-free ultraviolet (UV) microscopy images for hematological analysis.

### BACKGROUND

Deep ultraviolet microscopy (UV) is a high-resolution, label-free imaging technique that can yield quantitative molecular and structural information from biological samples due to the distinctive spectral properties of endogenous biomolecules in this region of the spectrum. Deep UV microscopy was recently applied for hematological analysis, which seeks to assess changes in the morphological, molecular, and cytogenetic properties of blood cells to diagnose and monitor several types of blood disorders. Modern hematology analyzers combine a variety of approaches such as absorption spectroscopy and flow cytometry to perform a complete blood count (CBC), i.e., measure blood cell counts (including red blood cell (RBC), platelet, neutrophil, eosinophil, basophil, lymphocyte, and monocyte) and Hemoglobin (Hb) content. These analyzers are expensive and require multiple chemical reagents for sample fixing and staining procedures that have to be performed by trained personnel. The inventors of this application have previously demonstrated that deep UV microscopy could serve as a simple, fast, and low-cost alternative to modem hematology analyzers and developed a multi-spectral UV microscope that enables high-resolution imaging of live, unstained whole blood smears at three discrete wavelengths. The chosen wavelengths are 260 nm (corresponding to the absorption peak of nucleic acids), 280 nm (corresponding to the absorption peak of proteins), and 300 nm (which does not correspond to an absorption peak of any endogenous molecule and can act as a virtual counterstain). In addition to high-resolution images showing cell morphology, UV absorption enables us to generate quantitative mass maps of nucleic acid and protein content in white blood cells (WBCs) as well as quantify the Hb mass in RBCs. By leveraging structural as well as molecular information, we can achieve a five-part white blood cell differential. Finally, the inventors also introduced a pseudocolorization scheme that uses the multi-spectral UV images at three wavelengths to generate images whose colors accurately recapitulate those produced by conventional Giemsa staining and can thus be used for visual hematological analysis.

Embodiments of the present disclosure address this technology as well as needs that will become apparent upon reading the description below in conjunction with the drawings.

### BRIEF SUMMARY

An exemplary embodiment of the present disclosure provides a method of virtually staining a biological sample, comprising: obtaining one or more UV images of the biological sample; generating a virtually stained image of the biological sample, comprising: generating a first data set for the one or more images, the first data set comprising at least one data value for each pixel of the one or more UV images; inputting the first data set into a deep learning neural network to generate one or more additional data sets, the one or more additional data sets comprising at least one data value corresponding to a value in a color model for each pixel in the one or more UV images; and creating virtually stained image of the biological sample using at least the one or more additional data sets.

In any of the embodiments disclosed herein, the first data set can comprise a lightness value in a Lab color model for each pixel of the one or more UV images, and the one or more additional data sets can comprise a second data set representing each pixel in the one or more UV images with a green-red value in the Lab color model and a third data set representing each pixel in the one or more UV images with a blue-yellow value in the Lab color model.

In any of the embodiments disclosed herein, the lightness values in the first data set can be between 0 and 100, the green-red values in the second data set can be between -127 and +127, and the blue-yellow values in the third data set can be between -127 and + 127.

In any of the embodiments disclosed herein, the one or more additional data sets can comprise a second data set representing each pixel in the one or more UV images with a red value in a RGB color model, a third data set representing each pixel in the one or more UV images with a blue value in the RGB color model, and a fourth data set representing each pixel in the one or more UV images with a green value in the RGB color model.

In any of the embodiments disclosed herein, the method can further comprise converting the at least one data values in the one or more additional data sets from a first color model to a second color model.

In any of the embodiments disclosed herein, the method can further comprise post-processing the one or more additional data sets with a histogram operation to alter a background hue in the virtually stained image.

In any of the embodiments disclosed herein, the one or more UV images can be taken at a center wavelength of 250-265 nm and a bandwidth of no more than 50 nm.

In any of the embodiments disclosed herein, the method can further comprise displaying the virtually stained image.

In any of the embodiments disclosed herein, the biological sample can comprise cells from blood or bone marrow.

In any of the embodiments disclosed herein, the method can further comprise classifying the cells in the biological sample using a deep learning neural network.

In any of the embodiments disclosed herein, classifying the cells can comprise: generating, from the one or more UV images, a first mask representative of cells in the biological sample; generating from the one or more UV images, a second mask representative of the nuclei in the biological sample; generating, based on the one or more UV images and the first and second masks, a feature vector; and classifying, using the first and second masks and the feature vector, cells in the biological sample by cell type.

In any of the embodiments disclosed herein, classifying the cells can further comprise determining whether the cells are dead or alive.

In any of the embodiments disclosed herein, the feature vector can comprise 512 features.

In any of the embodiments disclosed herein, the method can further comprise training the deep learning neural network using pairs of grayscale and pseudocolorized images.

In any of the embodiments disclosed herein, the deep learning neural network can be a generative adversarial network.

Another embodiment of the present disclosure provides a system for virtually staining a biological sample. The system can comprise a UV camera, one or more deep learning neural networks, and a display. The UV camera can be configured to take one or more UV images of the biological sample. The one or more deep learning neural networks can be configured to generate a virtually stained image of the biological sample by: obtaining a first data set for the one or more UV images, the first data set comprising at least one data value for each pixel of the one or more UV images; inputting the first data set into a deep learning neural network to generate one or more additional data sets, the one or more additional data sets comprising at least one data value corresponding to a value in a color model for each pixel in the one or more UV images; and creating a virtually stained image of the biological sample using at least the one or more additional data sets. The display can be configured to display the virtually stained image of the biological sample.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1: Top row provides normalized and registered intensity images corresponding to one tile; Middle row provides resulting pseudo-colorized image from the raw images in the top row (scale bar: 20 sum), and a 256×256 sample patch (scale bar: 5 sum) extracted from the image; Bottom row provides L, ‘a’ and ‘b’ channels of the sample patch after color space conversion, in accordance with an exemplary embodiment of the present disclosure.

FIG. 2A provides a schematic of a GAN, in accordance with an exemplary embodiment of the present disclosure.

FIG. 2B provides a schematic of the architecture for a discriminator of a GAN, in accordance with an exemplary embodiment of the present disclosure.

FIG. 2C provides a schematic of the architecture for a generator of a GAN, in accordance with an exemplary embodiment of the present disclosure.

FIGS. 3A-B illustrate a comparison of generated images and the ground truth with respect to the ‘a’ channel (FIG. 3A) and the colorized RGB images (FIG. 3B) for 3 exemplary image patches containing only red blood cells (RBCs), in accordance with an exemplary embodiment of the present disclosure.

FIG. 4 illustrates a comparison of the ground truth (top row) with the raw network output (middle row) and the final virtually stained images (bottom row) for 3 256×256 test image patches (scale bar in black represents 5 microns), in accordance with an exemplary embodiment of the present disclosure.

FIG. 5 illustrates a comparison of the ground truth (top row) with the raw network output (middle row) and the final virtually stained images (bottom row) for 3 1024×1024 patches from a single sample (scale bars represents 20 microns), in accordance with an exemplary embodiment of the present disclosure.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

Various embodiments of the present disclosure provide systems and methods of virtually staining biological samples, e.g., blood or bone marrow containing cells. These systems and methods can make use of deep learning neural networks to allow one or more UV images taken at a single wavelength (narrow bandwidth) to be used to generate the virtually stained colorized images. In some embodiments, the one or more UV images can comprise a single UV image or multiple non-overlapping or slightly-overlapping UV images. In some embodiments, the UV images can be taken at a single “center” wavelength between 200 nm and 400 nm, e.g., 260 nm, 280 nm, 300 nm. The UV images can also be taken at a narrow bandwidth, e.g., about 100 nm, about 75 nm, about 50 nm, about 25 nm, or about 10 nm. For example, in some embodiments, the one or more UV images can be taken at a center wavelength of 250-265 nm and a bandwidth of no more than 50 nm.

From the one or more UV images, virtually stained images of the biological sample can be generated. A first data set can be generated based on the one or more UV images. The first data set can comprise a data value for each pixel in the one or more UV images. For example, in some embodiments, the first data set can comprise a lightness value “L” in a Lab color model for each pixel of the one or more UV images. The lightness values in the first data set can be between 0 and 100.

In some embodiments, the first data set can be inputted into a deep learning neural network to generate one or more additional data sets. The deep learning neural network can be many different neural networks known to those skilled in the art, including, but not limited to, a generative adversarial network. Each of the one or more additional data sets generated by the neural network can comprise at least one data value corresponding to a value in a color model for each pixel in the one or more UV images. For example, in some embodiments, the one or more additional data sets can comprise a second data set representing each pixel in the one or more UV images with a green-red value in the Lab color model and a third data set representing each pixel in the one or more UV images with a blue-yellow value in the Lab color model. The green-red values in the second data set can be between -127 and +127, and the blue-yellow values in the third data set can be between -127 and +127. Alternatively, in some embodiments, the one or more additional data sets can comprise a second data set representing each pixel in the one or more UV images with a red value in a RGB color model, a third data set representing each pixel in the one or more UV images with a blue value in the RGB color model, and a fourth data set representing each pixel in the one or more UV images with a green value in the RBG color model.

Though the Lab color model and RGB color models are specifically disclosed herein, embodiments of the present disclosure are not limited to these two color models. Rather, as those skilled in the art will appreciate, various embodiments of the present disclosure can make use of many different color models, including but not limited to, Lab, RGB, HSV, YCbCr, and the like. Additionally, in some embodiments, the data values in the one or more additional data sets can be converted from a first color model to a second color model, using techniques known to those skilled in the art.

The one or more data sets representing data values for each pixel in a color model can then be used to generate a virtually stained colorized image of the biological sample corresponding to the one or more UV images. In some embodiments, the image can then be displayed on a display.

In some embodiments, post-processing can be performed on the one or more additional data sets with a histogram operation to alter and improve background hues in the resulting virtually stained image.

In some embodiments, a deep learning neural network can be used to classify the cells in the biological sample. Classifying the cells can comprise generating, from the one or more UV images, a first mask representative of cells in the biological sample and generating from the one or more UV images, a second mask representative of the nuclei in the biological sample. From the one or more UV images and the first and second masks, a feature vector can be generated. The feature vector can have any number of features. In some embodiments, as disclosed in detail below, the feature vector can comprise 512 features. The neural network can then use the first and second masks and the feature vector to classify the cells in the biological sample by cell type. In some embodiments, classifying the cells can comprise determining whether the cells are dead or alive.

### EXAMPLES

Certain examples of embodiments of the present disclosure are described below. These examples are for explanation only and should not be construed as limiting the scope of the present disclosure.

Below is disclosed a deep-learning framework to virtually stain single-channel UV images acquired at 260 nm, providing a factor of three improvement in imaging speed without sacrificing accuracy. The virtual staining problem is set up like an automatic image colorization problem, wherein an algorithm generates a realistic colorized image from an existing grayscale image input. Image colorization can be an ill-posed inverse problem because accurately predicting the color in an image region can require successfully inferring, e.g., three different values (R, G, and B intensity values per pixel), solely from the intensity in a grayscale image. Deep neural networks (DNNs) can achieve excellent performance in solving inverse problems and image translation tasks such as single image super-resolution, image reconstruction, and even image colorization. DNNs have also become ubiquitous in the processing, analysis, and digital staining of microscopy images. Thus, in the technique disclosed below, a conditional generative adversarial network (cGAN) is trained using image pairs comprising single-channel UV images of blood smears and their corresponding pseudocolorized images to generate realistic, virtually stained images. The network outputs can be post-processed using simple histogram operations to correct the background hue in the virtually stained images. The virtual staining scheme’s performance can be tested by computing the mean squared error (MSE) and the structural similarity index (SSIM) on each color channel.

### Experimental Setup and Data Acquisition

The multi-spectral deep-UV microscopy system was illuminated by an incoherent broadband laser-driven plasma light source (EQ-99X LDLS;Energetiq Technology). The source’s output was relayed through an off-axis parabolic mirror (Newport Corporation) and a short-pass dichroic mirror (Thorlabs). Bandpass UV filters at three wavelengths - 260, 280 and 300 nm (~ 10 nm FWHM bandwidth) mounted on a on a filter wheel enable multi-spectral imaging. A 40× microscope objective (NA 0.5) (LMU-40X; Thorlabs) was used for imaging (achieving an average spatial resolution of ~ 280 nm) and images were recorded on a UVsensitive charge-coupled device (pco. UV; PCO AG) camera (integration time = 30 to 100 ms). The sample was focused at different wavelengths and translated via a high-precision motorized stage (MLS2031; Thorlabs). A full-field of view of 1 × 2-mm area was acquired in approximately three minutes at each wavelength by raster-scanning the sample and capturing a series of smaller tiles (170 µm × 230 µm).

Fresh blood smears of healthy donors and patients were prepared and imaged with deep UV microscopy at the chosen wavelengths. Each image was normalized by a reference background image acquired from a blank area on the sample at each wavelength. The images at the three wavelengths corresponding to each field of view were then coregistered using an intensity-based image registration algorithm (based on MATLAB’s (Mathworks) imregister).

### Data Preparation

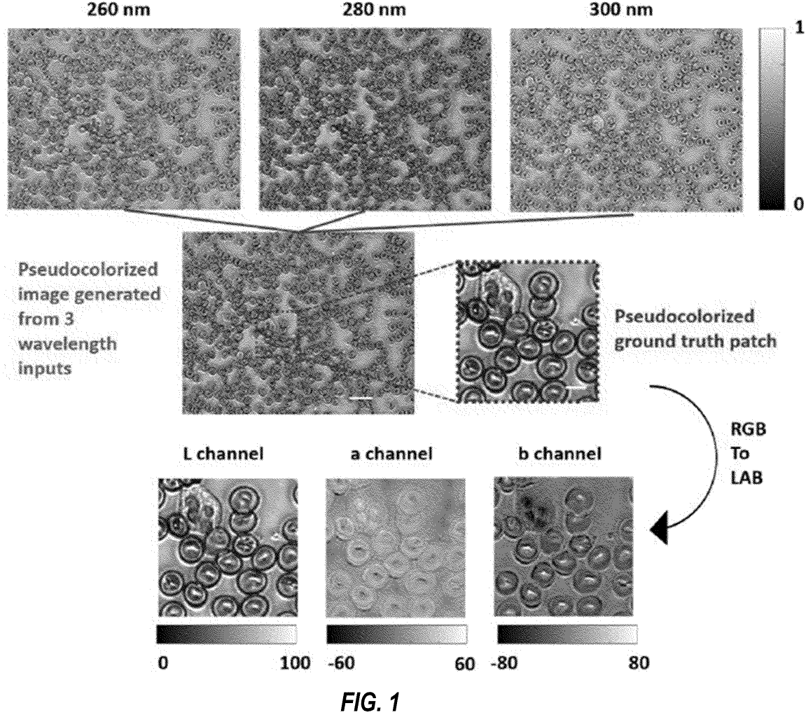

The registered intensity image stacks (260-, 280-, and 300-nm wavelength images) for each tile were then used to obtain pseudocolorized RGB images and served as the ground truth for the virtual staining. The top row of FIG. 1 shows the raw data and the middle row shows the pseudocolorized image. The UV absorption peak of nucleic acids is close to 260 nm, and hence images at this wavelength have the maximum nuclear contrast. Thus, the single-channel UV image at 260 nm serves as the grayscale image for virtual staining. From each tile of 1040×1392 pixels, 25 256×256 image patches were extracted with minimal overlap, resulting in about 35,000 image patches (see sample patch in FIG. 1). Pairs of grayscale and pseudocolorized image patches were used for training.

In the RGB color space, all three channels contain color information. The CIELAB (LAB or Lab) color space is an alternative representation to RGB color space, where the intensity (the grayscale image) is encoded by the luminance channel (L) and color information is encoded in the two other channels (‘a’ and ‘b’). The L values range from 0 (black) to 100 (white), while ‘a’ ranges from green (-127) to red (+127) and ‘b’ from blue (-127) to yellow (+127). The L, ‘a’ and ‘b’ channels of the ground truth patch are shown in FIG. 1. The LAB color space is useful since all the color information is contained in only two channels. Thus, the colorization scheme must only predict two output color channels with the grayscale input serving as the L channel. This reduces training time and complexity and enables more efficient training. Additionally, structure is better preserved in the final image since the L-channel retains all the structure in the input image. Therefore, this network was trained in the LAB color space; the ground truth RGB images were converted to the LAB color space, and the network predicts the ‘a’ and ‘b’ color channels, which were concatenated with the grayscale input to generate the LAB image.

### Network Architecture

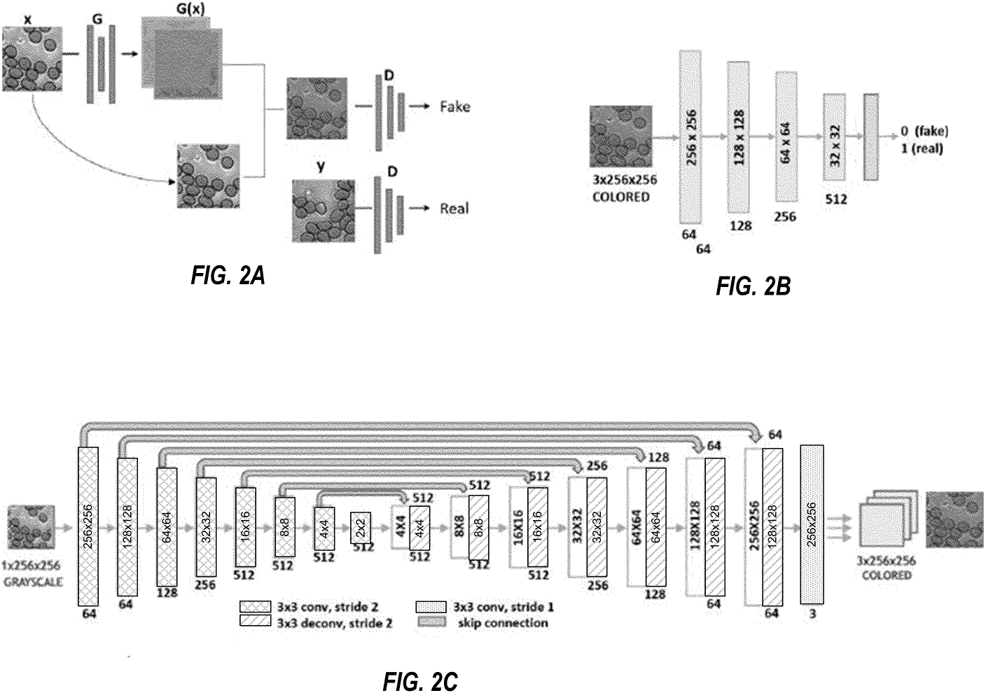

GANs are a type of deep neural network based generative model and can be successfully applied to several image generation and translation tasks, including image colorization. GANs comprise a combination of two networks (shown in FIG. 2A) - a generator (FIG. 2C) that generates new examples of data, and a discriminator (FIG. 2B) that attempts to distinguish the generated examples from examples in the original dataset - that are simultaneously trained. In a traditional GAN, the input of the generator is randomly generated noise data z. However, in the case of the colorization problem herein, a grayscale image serves as the input rather than noise. Thus, techniques herein can use a conditional GAN (cGAN), where the grayscale input (L channel) serves as a prior for the ‘a’ and ‘b’ channel images estimated by the generator.

The generator can be a fully convolutional network with encoding and decoding paths with skip connections, based on the U-net (shown in FIG. 2C). In the encoding or downsampling path, 3×3 convolutional kernels were used with strided convolutions (stride of 2), followed by batch normalization (to help prevent mode collapse), and a leaky ReLU (LReLU) activation function with a slope of 0.2. For any input x the activation functions are defined as

$$\text{ReLU} \left(x\right) = \left\{\begin{matrix}x & \text{(1)} x > 0 \\ 0 & \text{otherwise}\end{matrix}\right) \text{LReLU} \left(x\right) = \left\{\begin{matrix}x & \text{for} x > 0 \\ 0.2 x & \text{otherwise}\end{matrix}\right)$$

The decoding path uses 3×3 transposed convolutions with a stride of 2 to perform the upsampling, followed by batch normalization and a ReLU activation function. The architecture of discriminator (shown in FIG. 2B) is similar to the encoding path of the generator, but using the leaky ReLU activation for better performance, and a sigmoid activation for the last layer.

### Training Specifications

Objective Function: The GAN was trained via a minmax game that completes upon reaching Nash equilibrium between the generated and the real data, quantified using the Jensen-Shannon divergence. A modified version of the cost function was used to avoid vanishing gradients and because of its non-saturating nature. The following cost functions were used:

$$\begin{matrix}{min}_{{s}_{a}} {J}^{\left(\text{G}\right)} \left({θ}_{D} , {θ}_{O}\right) = {min}_{{s}_{a}} - {E}_{x} \left[log \left(D \left(G \left({0}_{2} \left|x\right)\right)\right)\right)\right] + \\ λ {\left‖G \left({0}_{x} \left|x\right)\right) - y\right‖}_{1}\end{matrix}$$

$$\begin{matrix}{max}_{{s}_{a}} {J}^{\left(I\right)} \left({θ}_{D} , {θ}_{O}\right) = {max}_{{s}_{a}} - \left({E}_{y}\right) \left[log \left(D \left(y \left|x\right)\right)\right)\right] + \\ \left({E}_{y} \left[log \left(1 - D \left(G \left({0}_{2} \left|x\right)\right) \left|x\right)\right)\right)\right]\right)\end{matrix}$$

where, G represents the generator, D represents the discriminator, x represents the grayscale image, y is the color label, 0_{z}|x represents zero noise in the input with the grayscale image as a prior, λ||G(0_{z}|x) - y||1 represents a total variation regularization term to ensure structural similarity between the input and the colorized output.

Training Considerations and Hyperparameter Selection: Adam was used to optimize training, with a weight initialization. A small momentum value of 0.5 was used, as large momentum values can lead to instability. The hyper-parameter λ used for regularization was 100. The target labels 0 and 1 of the discriminator were replaced with smoothed values 0 and 0.9 (smoothing only positive labels though, to improve discriminator performance), shown to be an effective regularization method. A batch size of 8 images was used to manage computational costs.

### Post-Processing

To ensure that the backgrounds across image patches were uniform and match the ground-truth pseudocolorized images, traditional image processing techniques for contrast enhancement were used and applied to all three channels of the image in the LAB color space. The histogram of the L channel was expanded so that the bottom 1% and top 1% of the pixels were saturated. A single reference image was chosen and converted to the LAB color space for channel-wise histogram matching for the ‘a’ and ‘b’ channels, implemented in MATLAB (Mathworks). The structural similarity index measure (SSIM) was computed for each channel of the RGB images. The SSIM between two images x and y was calculated as

$$\text{SSIM} \left(x , y\right) = \frac{\left(2 {μ}_{2} {μ}_{y} + {C}_{1}\right) \left(2 {σ}_{x y} + {C}_{2}\right)}{\left({μ}_{x}^{2} + {μ}_{s}^{2} + {C}_{1}\right) \left({σ}_{x}^{2} + {σ}_{s}^{2} + {C}_{2}\right)} \qquad \text{(2)}$$

where µₓ, µ_{y}, σₓ, σ_{y}, and σxy, were the means, standard deviations, and cross-covariance for the two images. Here, each color channel was treated as an independent image. The SSIM values ranged from -1 to +1 with a value of + 1 indicating that the images were identical.

### Results and Discussion

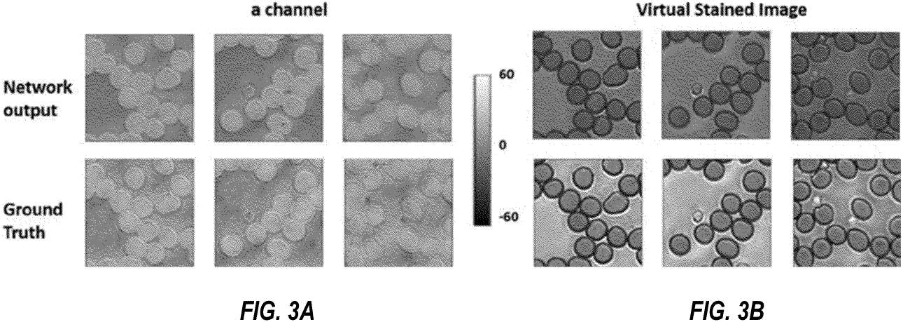

The network was blind tested on ~ 1800 test patches. It can be seen that the network was able to produce realistic colorized images for image patches that contain only red blood cells in FIGS. 3. However, the background was darker than in the ground truth images. Additionally, the background hue was not consistent across ground truth image patches and varied slightly depending on the original sample from which the patch was extracted. Thus post-processing was introduced to result in uniform background hues while also improving the image contrast.

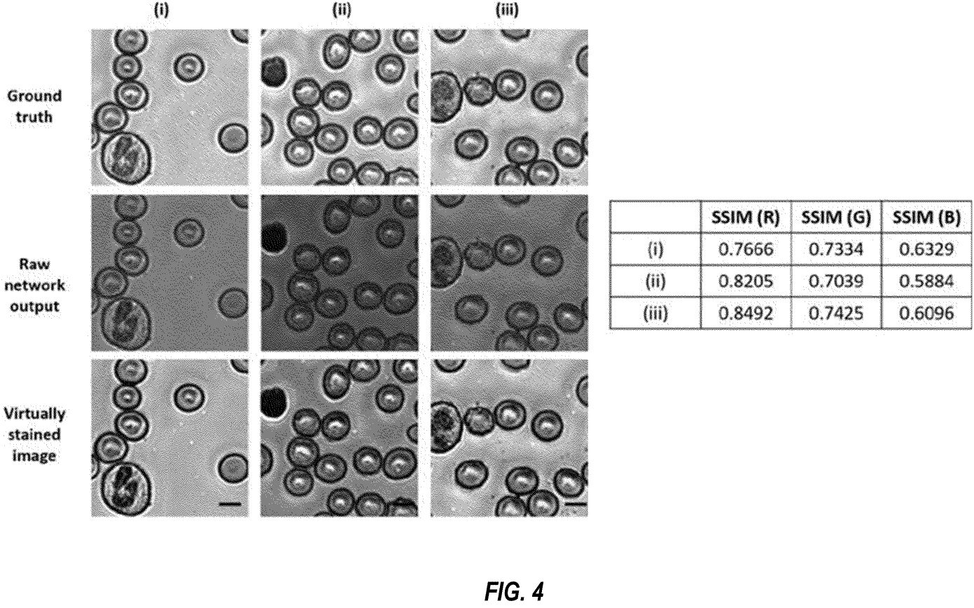

It may be desirable for the network to be able to recapitulate the nuclear contrast in the ground truth for further analysis and segmentation. Looking at some test patches containing WBCs in FIG. 4, it can be seen that the raw network output had good nuclear contrast, but the background regions appeared darker. After the post-processing steps, the images resembled the ground truth images very closely. As evidenced by the SSIM values and visual inspection, the virtual staining was not perfect but still very realistic. The blue channel had the lowest SSIM values because the nuclei in the virtually stained images appeared to be a slightly brighter blue than in the ground truth images. Hence, the virtually stained images had apparently better nuclear contrast than the ground truth.

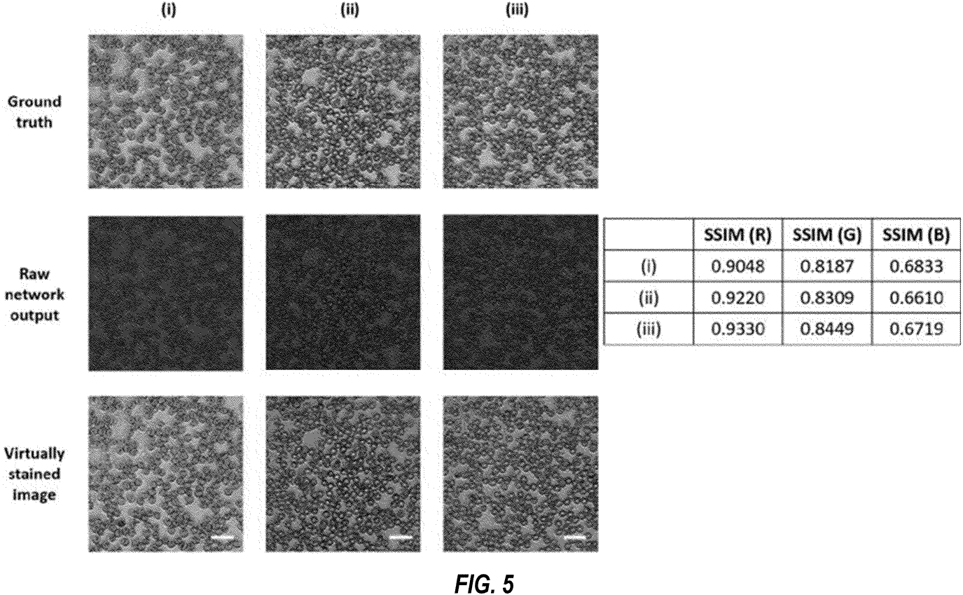

Since a fully convolutional network was used, larger colorized images can be generated using 1024×1024 image patches as inputs. The images in FIG. 5 show the good agreement between the virtually stained images (obtained using only a single grayscale input) and the ground truth images, also supported by the SSIM values. The SSIM values of the red and green channel were slightly higher when compared to the 256×256 patches. Once again, the blue channel had the lowest SSIM values.

It was assumed that the single-channel image at 260 nm was equivalent to the L channel of the ground truth to train the network. While this dramatically simplified the network’s training by predicting only a 2-channel output instead of three channels, this is an oversimplification. Nevertheless, the post-processing framework successfully compensated for visual appearance (and quantitative) differences introduced by this assumption/simplification, minimizing the error in the resulting virtually stained images. The LAB color space is advantageous because it uses only two-color channels instead of three. However, artifacts such as aberrations in the single (260 nm) input image appear more pronounced than in ‘a’ and ‘b’ channels than in the R, G, and B channels of the RGB color space. A potential approach to mitigate this issue is to estimate the three-color channels in RBG, HSV, or YCbCr, which can be done in accordance with other embodiments of this disclosure.

As shown in the examples above, a deep-learning-based framework can be used to generate virtually stained images of blood smears that resemble the gold-standard Giemsastained images. A generative adversarial network can be trained with deep-UV microscopy images acquired at 260 nm. Certain assumptions can be made to simplify the network architecture and training procedure and develop a straightforward post-processing scheme to correct the errors resulting from these assumptions. The virtually stained images generated from a single grayscale image were very similar to those obtained from a pseudocolorization procedure using a three-channel input with high SSIM values. The virtual staining method can eliminate the need to acquire images at different wavelengths, providing a factor of three improvement in imaging speed without sacrificing accuracy. This can allow for a faster and more compact label-free, point-of-care hematology analyzer. Virtual staining is a significant first step towards a fully automated hematological analysis pipeline that includes segmentation and classification of different blood cell types to compute metrics of diagnostic value.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. A method of virtually staining a biological sample, comprising:
obtaining one or more UV images of the biological sample;
generating a virtually stained image of the biological sample, comprising:
generating a first data set for the one or more images, the first data set comprising at least one data value for each pixel of the one or more UV images;
inputting the first data set into a deep learning neural network to generate one or more additional data sets, the one or more additional data sets comprising at least one data value corresponding to a value in a color model for each pixel in the one or more UV images; and
creating virtually stained image of the biological sample using at least the one or more additional data sets.

2. The method of claim 1, wherein the first data set comprises a lightness value in a Lab color model for each pixel of the one or more UV images, and wherein the one or more additional data sets comprises a second data set representing each pixel in the one or more UV images with a green-red value in the Lab color model and a third data set representing each pixel in the one or more UV images with a blue-yellow value in the Lab color model.

3. The method of claim 1, wherein the lightness values in the first data set are between 0 and 100, wherein the green-red values in the second data set are between -127 and +127, and wherein the blue-yellow values in the third data set are between -127 and +127.

4. The method of claim 1, wherein the one or more additional data sets comprises:
a second data set representing each pixel in the one or more UV images with a red value in a RGB color model;
a third data set representing each pixel in the one or more UV images with a blue value in the RGB color model; and
a fourth data set representing each pixel in the one or more UV images with a green value in the RGB color model.

5. The method of claim 1, further comprising converting the at least one data values in the one or more additional data sets from a first color model to a second color model.

6. The method of claim 1, further comprising post-processing the one or more additional data sets with a histogram operation to alter a background hue in the virtually stained image.

7. The method of claim 1, wherein the one or more UV images are taken at a center wavelength of 250-265 nm and a bandwidth of no more than 50 nm.

8. The method of claim 1, further comprising displaying the virtually stained image.

9. The method of claim 1, wherein the biological sample comprises cells from blood or bone marrow.

10. The method of claim 9, further comprising classifying the cells in the biological sample using a deep learning neural network.

11. The method of claim 10, wherein classifying the cells comprises:
generating, from the one or more UV images, a first mask representative of cells in the biological sample;
generating from the one or more UV images, a second mask representative of the nuclei in the biological sample;
generating, based on the one or more UV images and the first and second masks, a feature vector;
classifying, using the first and second masks and the feature vector, cells in the biological sample by cell type.

12. The method of claim 11, wherein classifying the cells further comprises determining whether the cells are dead or alive.

13. The method of claim 11, wherein the feature vector comprises 512 features.

14. The method of claim 1, further comprising training the deep learning neural network using pairs of grayscale and pseudocolorized images.

15. The method of claim 1, wherein the deep learning neural network is a generative adversarial network.

16. A system for virtually staining a biological sample, comprising:
a UV camera configured to take one or more UV images of the biological sample;
one or more deep learning neural networks configured to generate a virtually stained image of the biological sample by:
obtaining a first data set for the one or more UV images, the first data set comprising at least one data value for each pixel of the one or more UV images;
inputting the first data set into a deep learning neural network to generate one or more additional data sets, the one or more additional data sets comprising at least one data value corresponding to a value in a color model for each pixel in the one or more UV images; and
creating virtually stained image of the biological sample using at least the one or more additional data sets; and
a display configured to display the virtually stained image of the biological sample.

17. The system of claim 16, wherein the first data set comprises a lightness value in a Lab color model for each pixel of the one or more UV images, and wherein the one or more additional data sets comprises a second data set representing each pixel in the one or more UV images with a green-red value in the Lab color model and a third data set representing each pixel in the one or more UV images with a blue-yellow value in the Lab color model.

18. The system of claim 16, wherein the one or more additional data sets comprises:
a second data set representing each pixel in the one or more UV images with a red value in a RGB color model;
a third data set representing each pixel in the one or more UV images with a blue value in the RGB color model; and
a fourth data set representing each pixel in the one or more UV images with a green value in the RGB color model.

19. The system of claim 16, wherein the one or more UV images are taken at a center wavelength of 250-265 nm and a bandwidth of less than 50 nm.

20. The system of claim 16, wherein the biological sample comprises cells from blood or bone marrow, and wherein the one or more deep learning neural network are further configured to classify the cells in the biological sample.
